(19) United States
(12) Patent Application Publication
(10) Pub. No.: US 2025/0380243 A1
(43) Pub. Date: Dec. 11, 2025

(54) Ambient Internet Of Things Paging Procedures And Signaling In Wireless Communications

(71) Applicant: MediaTek Inc., Hsinchu City (TW)

(72) Inventors: Nathan Edward Tenny, San Jose, CA (US); Per Johan Mikael Johansson, Singapore (SG)

(21) Appl. No.: 19/212,611

(22) Filed: May 19, 2025

Related U.S. Application Data
(60) Provisional application No. 63/658,530, filed on Jun. 11, 2024.

(51) Int. Cl. H04W 68/00

(52) U.S. Cl. CPC H04W 68/005

(57) ABSTRACT

Various techniques pertaining to ambient Internet of Things (AIoT) paging procedures and signaling in wireless communications are described. In a method of processing a paging message in an AIoT system, a device receives the paging message and processes at least one paging record contained in the paging message by: (a) matching a device identifier (ID) in the paging record to at least one identifier assigned to the device; (b) determining whether the paging record requests a response; and (c) responsive to determining that the paging record requests the response, initiating an AIoT random access procedure on one or more radio resources determined in accordance with a content of the paging message.

### CROSS REFERENCE TO RELATED PATENT APPLICATION

The present disclosure is part of a non-provisional patent application claiming the priority benefit of U.S. Provisional Patent Application No. 63/658,530, filed 11 Jun. 2024, the content of which herein being incorporated by reference in its entirety.

### TECHNICAL FIELD

The present disclosure is generally related to wireless communications and, more particularly, to ambient Internet of Things (AIoT) paging procedures and signaling in wireless communications.

### BACKGROUND

Unless otherwise indicated herein, approaches described in this section are not prior art to the claims listed below and are not admitted as prior art by inclusion in this section.

In an AIoT system, simple “devices” interact with more sophisticated “readers” to communicate limited information. The devices may be extremely power-limited, potentially having no batteries and relying solely on energy harvesting for operation, or the devices may potentially have batteries of very limited capacity. Simplicity of such devices is considered critical, because they are required to be low-cost devices that can be widely deployed in large numbers (e.g., a “tag” device for every item in a warehouse or shipment). For most of the lifetime of a device, the device is expected not to be active in the sense of transmitting data. In current AIoT system designs, data are communicated in a device-terminated (DT) or device-originated/device-terminated-triggered (DO-DTT) manner, with either model depending on the reader initiating contact with the device. The reader may be associated with (for example, physically collocated with) a user equipment (UE) or a base station (BS) of a cellular system, but the device may not be considered as an element of the cellular system, and the AIoT interface between the reader and the device may not be part of the corresponding cellular radio access technology.

In a DT operation, the reader first attempts to contact the device (potentially without prior knowledge of whether the device is present in the reader's coverage area) with a first message, which may be referred to as a “paging” message, an “initial trigger” message, and so on. The first message has some resemblance to paging messages in cellular communications but, unlike cellular paging, the first message is not connected with a concept of mobility in a network service area and does not result in bringing the device into a “connected mode” with the reader. Nevertheless, the first message is herein referred to as an “AIoT paging message” (or simply a “paging message” when there is no ambiguity) in the present disclosure. After this paging message arrives at the device, the device may respond with a random-access-like procedure, which allows the device to communicate some basic information to the reader (e.g., a device identity), and the reader may conterminously or subsequently transmit other information, such as application data, to the device. In some cases, the DT data may be carried as part of the paging message, meaning that there may be no need to transmit subsequent information (such as application data) from the reader to the device after the paging and/or access procedures have completed.

In a DO-DTT operation, the flow of application data is from the device to the reader, but the procedure is still initiated by the reader. The reader first attempts to contact the device with an AIoT paging message, and the device responds with a random-access-like procedure to establish communication with the reader. The random-access-like procedure may allow the device to transmit some data (e.g., a device identity and/or a small packet of application data) to the reader and, after the random-access-like procedure concludes, the device may transmit further information such as application data to the reader.

Interactions between the device and the reader on the AIoT interface may be summarized by the following generic procedure: (1) based on a service request (e.g., from upper layers), the reader sends an AIoT paging message indicating one or more devices that need to respond; (2) the triggered device(s) perform the random-access-like procedure, if needed (for instance, if they are not already in active communication with the reader); and (3) the device(s) perform data communication with the reader, if needed (for instance, if the device and the reader have not transferred all required data in one and/or both directions during the paging and random-access-like procedures).

At the time of the present disclosure, details of the format and contents of the AIoT paging message and paging procedure are not yet defined in pertinent standards, such as the 3^{rd} Generation Partnership Project (3GPP) standard. Therefore, there is a need for a solution of AIoT paging procedures and signaling in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to AIoT paging procedures and signaling in wireless communications.

In one aspect, a method of processing a paging message in an AIoT system may involve a device receiving the paging message. The method may also involve the device processing at least one paging record contained in the paging message by: (a) matching a device identifier (ID) in the paging record to at least one identifier assigned to the device; (b) determining whether the paging record requests a response; and (c) responsive to determining that the paging record requests the response, initiating an AIoT random access procedure on one or more radio resources determined in accordance with a content of the paging message.

In another aspect, a method of transmitting a paging message in an AIoT system may involve a reader encoding, in the paging message, a message type corresponding to paging. The method may also involve the reader encoding, in the paging message, at least one paging record addressed to at least one device of the AIoT system by: (a) encoding, in the paging record, a device ID assigned to the device; and (b) encoding, in the paging record, an indication of whether the paging record requests a response from the device. The method may further involve the reader transmitting the paging message to the device.

It is noteworthy that, although description provided herein may be in the context of certain radio access technologies, networks and network topologies such as, 5th Generation (5G)/New Radio (NR), 6th Generation (6G) the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Industrial IoT (IIoT), narrowband IoT (NB-IoT), Wi-Fi (or WiFi), Bluetooth and ZigBee. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram illustrating an AIoT system under a proposed scheme in accordance with the present disclosure.

FIG. 2 is a flow diagram illustrating a generic AIoT procedure under a proposed scheme in accordance with the present disclosure.

FIG. 3 is a diagram illustrating a first example of protocol stacks for an AIoT operation under a proposed scheme in accordance with the present disclosure.

FIG. 4 is a diagram illustrating a second example of protocol stacks for an AIoT operation under a proposed scheme in accordance with the present disclosure.

FIG. 5 is a diagram illustrating a high-level structure of an exemplary format of an AIoT paging message under a proposed scheme in accordance with the present disclosure.

FIG. 6 is a diagram illustrating a detailed PDU format for an exemplary AIoT paging message under a proposed scheme in accordance with the present disclosure.

FIG. 7 is a flowchart illustrating the processing of an exemplary AIoT paging message by a device under a proposed scheme in accordance with the present disclosure.

FIG. 8 is a block diagram of an example communication system under a proposed scheme in accordance with the present disclosure.

FIG. 9 is a flowchart of an example process under a proposed scheme in accordance with the present disclosure.

FIG. 10 is a flowchart of an example process under a proposed scheme in accordance with the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to AIoT paging procedures and signaling in wireless communications. According to the present disclosure, a number of possible solutions may be implemented separately or jointly. That is, although these possible solutions may be described below separately, two or more of these possible solutions may be implemented in one combination or another.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

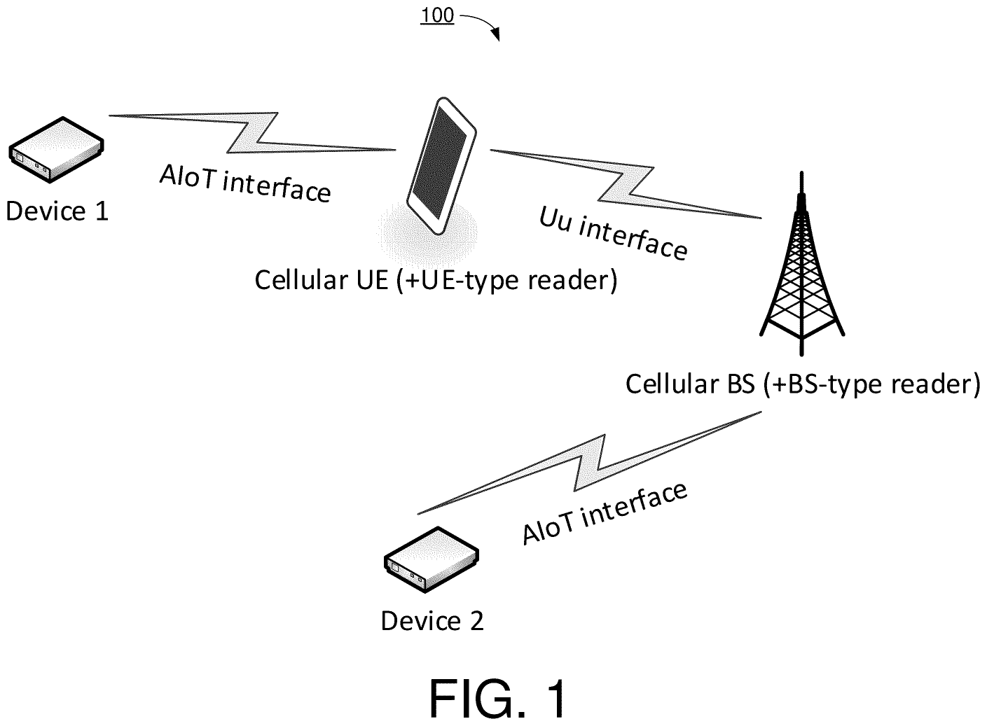

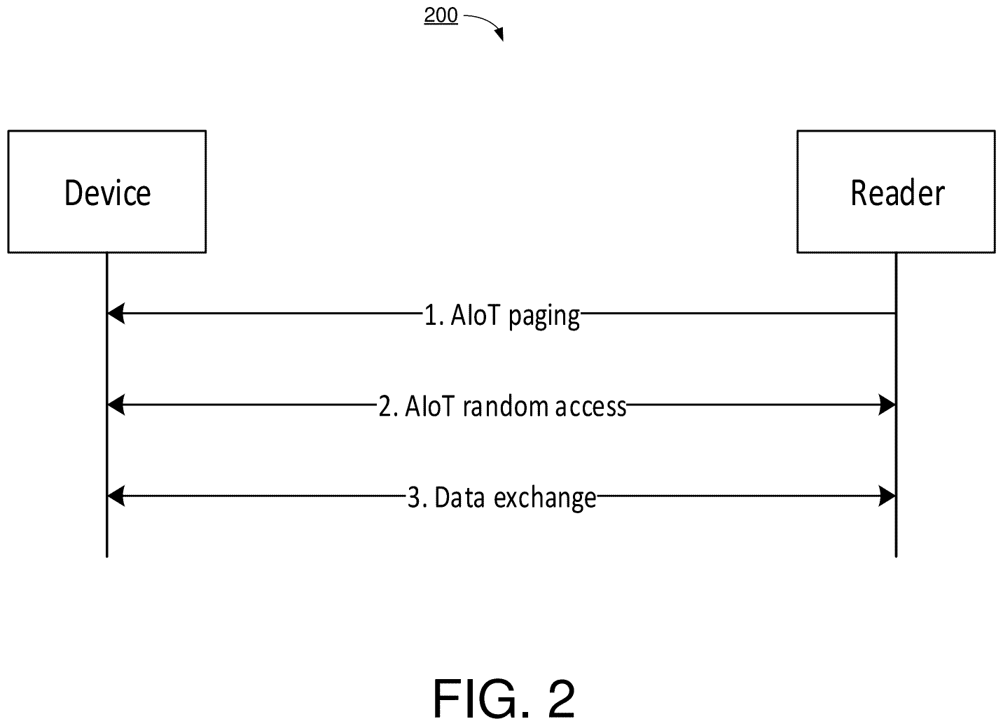

FIG. 1 illustrates an AIoT system 100 under a proposed scheme in accordance with the present disclosure. Referring to FIG. 1, a cellular BS supports a “BS-type” AIoT reader, and a cellular UE supports a “UE-type” AIoT reader; with the UE and the BS being connected via a Uu interface of a cellular system (e.g., a 5G system). The UE (or, more precisely, a reader associated with the UE) communicates with a first AIoT device (labelled “Device 1” in FIG. 1) on an AIoT interface, and the BS (or, more precisely, a reader associated with the BS) communicates with a second AIoT device (labelled “Device 2” in FIG. 2) on an AIoT interface. The BS may interact with the UE over the Uu interface to control operations of the UE reader. For instance, the BS may control the UE by forwarding upper-layer signaling from an AIoT controller located in the cellular network (not shown), although the operations on the respective AIoT interfaces of the two readers may be independent of one another. That is, the interaction of the BS with the UE to support operations of the UE as an AIoT reader may be independent of any operations of the BS as an AIoT reader. In addition to the configuration shown in FIG. 1, a UE supporting a UE-type AIoT reader may be served by a BS that does not support a BS-type AIoT reader, and/or a BS supporting a BS-type AIoT reader may serve one or more UEs that do not support a UE-type AIoT reader.

FIG. 2 illustrates a generic AIoT procedure 200 under a proposed scheme in accordance with the present disclosure. Procedure 200 may pertain to a generic AIoT procedure between a reader and a device. The reader may be UE-type or BS-type, and data transfer may be based on a DT procedure, a DO-DTT procedure, or a combination of the two. Referring to FIG. 2, in step 1, the reader transmits to the device an AIoT paging message. The potential contents of the paging message and other details of this step are further described below. In step 2, the device and the reader perform an “AIoT random access” procedure in which the device communicates with the reader to transfer some amount of application data and/or other information such as a device identity. Step 2 may involve various procedures, such as a 2-step, 3-step, or 4-step access procedure, the details of which are not discussed here. The essential aspect is of step 2 is that, after the completion of the random access procedure, the device and reader can engage in further data transfer if necessary. In step 3, the device and reader may exchange data (in either direction or both). The data may include data of an overlying application, control signaling between the reader and the device, information to be transferred by upper layers of a protocol stack, and so on.

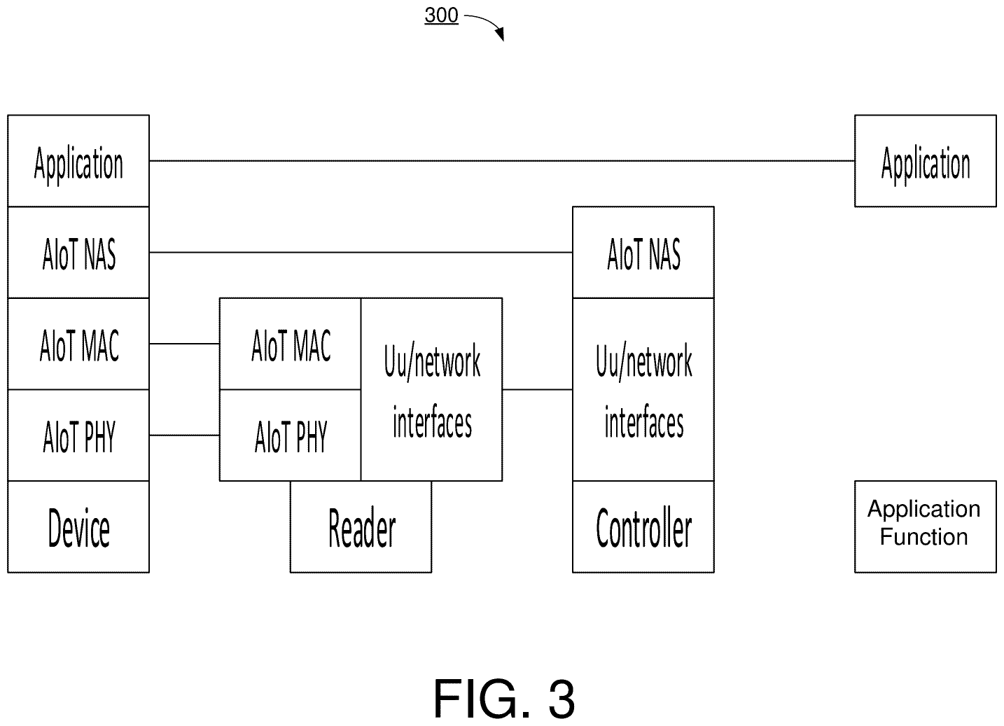

FIG. 3 illustrates a first example 300 of protocol stacks for an AIoT operation under a proposed scheme in accordance with the present disclosure. Referring to FIG. 3, first example 300 may pertain to protocol stacks for an AIoT operation among a device, a reader, a controller, and an application function. The device instantiates an AIoT physical (PHY) layer, an AIoT medium access control (MAC) layer, an AIoT non-access stratum (NAS) signaling layer, and an application layer. The reader instantiates an AIoT PHY layer and an AIoT MAC layer for communication with the corresponding layers in the device. Moreover, the reader communicates with the controller via some combination of Uu and/or network interfaces. The controller may, for example, be embodied at an access and mobility management function (AMF) of a cellular network. The controller instantiates appropriate protocol layers for these interfaces, along with an AIoT NAS layer in correspondence with the AIoT NAS layer at the device. Details of communications between the controller and the application function are not shown in FIG. 3. The application function instantiates an application layer in correspondence with the application layer in the device. The paging procedures described herein may be understood as functions of the AIoT MAC layer, and the application data transferred to and/or from the device may be understood as belonging to the application layer.

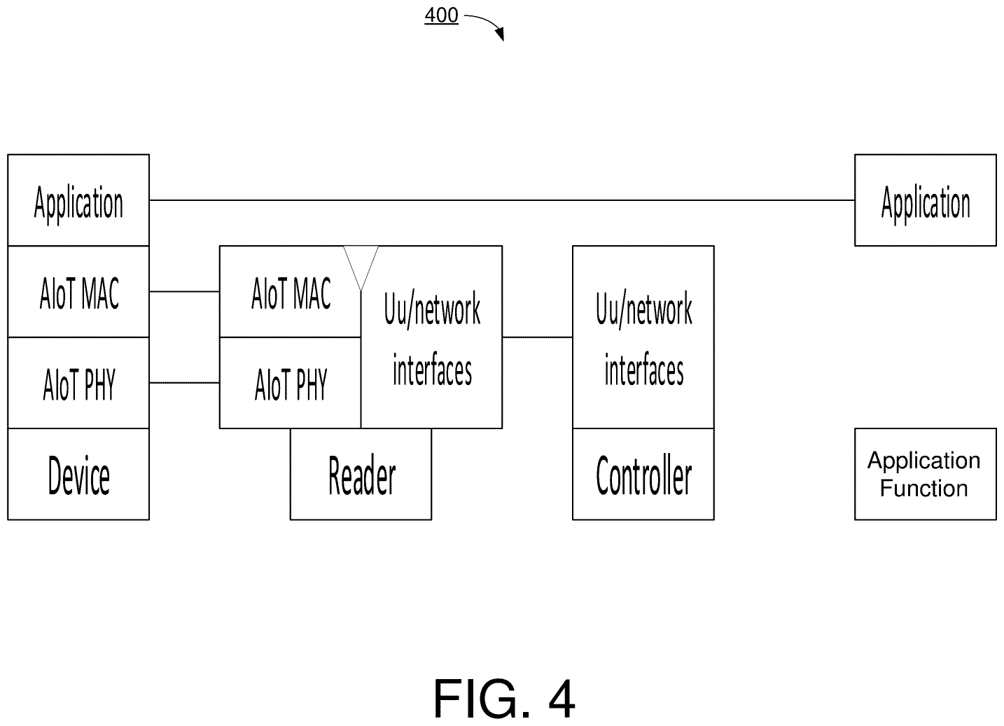

FIG. 4 illustrates a second example 400 of protocol stacks for an AIoT operation under a proposed scheme in accordance with the present disclosure. Referring to FIG. 4, first example 400 may pertain to protocol stacks for an AIoT operation among a device, a reader, a controller, and an application function. The device instantiates an AIoT PHY layer, an AIoT MAC layer, and an application layer. The reader instantiates an AIoT PHY layer and an AIoT MAC layer, in correspondence with the layers of the device, and communicates with the controller using a combination of Uu and/or network interfaces. The controller may, for example, be embodied at an AMF of a cellular network. The controller instantiates the layers needed to communicate with the reader (the details of which are not shown in FIG. 4, but which may, for instance, involve lower-layer transport and/or a suitable application protocol for the logical interface between the controller and the reader). The reader acts as a relay to transfer information between the controller and the device using the AIoT MAC layer for communication with the device. The application function instantiates an application layer, in correspondence with the application layer in the device, and the details of communication between the controller and the application function are not shown. The effect of these “flat” protocol stacks is that the device sees itself as communicating only with the reader and the application function, and any transfer of information (such as NAS signaling) with the controller is handled as a relay function through the reader. Compared to the more heavily layered protocol stacks of FIG. 3, these protocol stacks in FIG. 4 may facilitate a simpler design/production/testing life cycle for the device. As with FIG. 3, the paging procedures described herein may be understood as functions of the AIoT MAC layer, and the application data transferred to and/or from the device may be understood as belonging to the application layer.

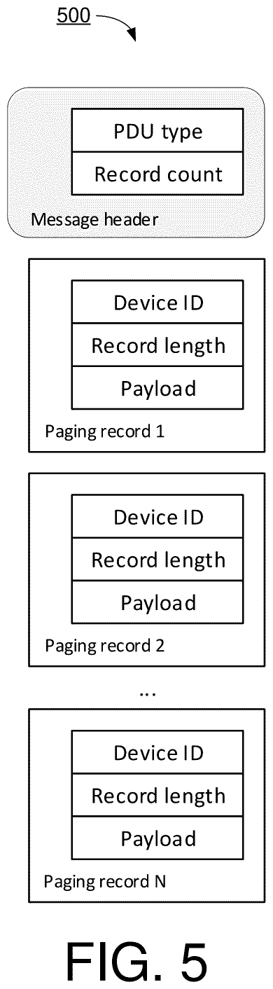

FIG. 5 illustrates a high-level structure 500 of an exemplary format of an AIoT paging message under a proposed scheme in accordance with the present disclosure. Referring to FIG. 5, the message format may include a message header and one or more paging records, where each record may address a single device, a plurality of devices, or all devices that receive the message. In the example shown in FIG. 5, the message header includes a “PDU type” field, which identifies a particular protocol data unit (PDU) as containing an AIoT paging message. The PDU may, for example, be a PDU of an AIoT MAC protocol. The message header as shown further includes a record count, identifying the number of paging records that follow the header. Each paging record includes a device identifier (ID), a record length, and a payload. The device ID identifies one or more devices that should receive and act on this paging record. In some instances, the device ID may be an identifier of a single device, such as a short radio network temporary identifier (S-RNTI), a long-term temporary identifier, or a permanent or semi-permanent identifier that may, for example, be assigned to the device at the time of manufacture or at the time of provisioning for operation in the AIoT system. In other instances, the device ID may be an identifier applying to more than one device, such as a mask or prefix of a device identifier (e.g., assuming 32-bit identifiers, a mask value in hexadecimal of 0x1234ffffffffffff may mean “all devices whose identifiers begin with 1234”) or a group identifier (e.g., a common value provisioned to a set of devices so that they can be addressed as a group later). In addition, in some instances, a special case of the group identifier may be an identifier meaning “all devices that receive the message” (e.g., a reserved value (such as all-bits-1 or all-bits-0) that is interpreted to match for every device or a distinguished broadcast identifier type). The record length may identify the total length of this paging record or the length of a variable-sized subset of the record such as the payload. Thus, it may be necessary to provide this length information to allow devices to parse the paging record unambiguously, and it may also be helpful to allow devices that are not addressed by this paging record to skip the entire record and examine the next record in the message. The record length may be in any suitable units, e.g., bits or octets. The payload may be a fixed-length or variable-length block of data, which may, for instance, carry data from an upper layer of the protocol stacks such as the application layer. In some embodiments, the payload may be padded to a certain length (such as an integer multiple of 8 bits) by including padding bits following the data. Additional fields, such as a paging cause code, a device ID type, a transaction number, a length of the payload (as distinct from the total length of the record), a data included indicator, a new data response only indicator, and so on, may further be included in the message, either in the message header or in the paging record format. (The functionality of some of these potential fields will be discussed further below.) Such additional fields may be considered as a part of the message header, a part of a header for an individual paging record, or a part of the payload of a paging record, the essential commonality being that their values are available to a device that receives the paging message and parses a particular paging record. The total number of paging records included in the message (shown as N in FIG. 5) may correspond to a value of the record count field in the message header.

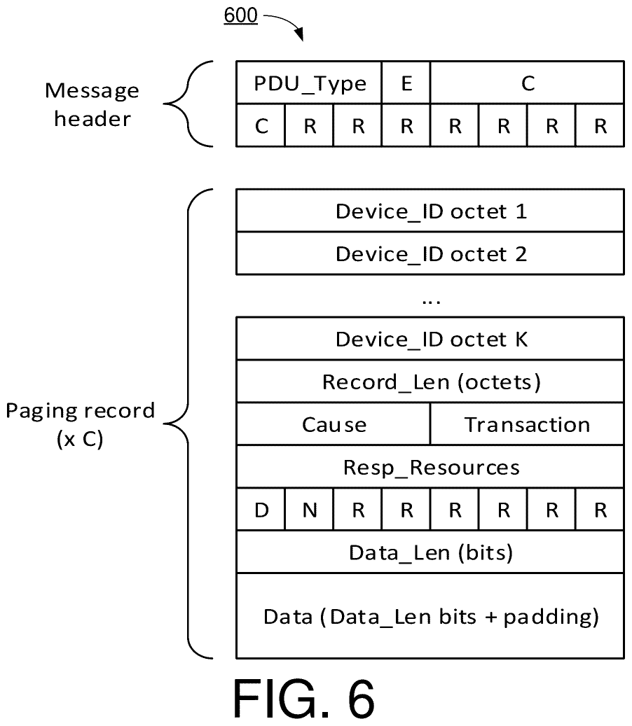

FIG. 6 illustrates a detailed PDU format 600 for an exemplary AIoT paging message under a proposed scheme in accordance with the present disclosure. It is noteworthy that the fields, field names, order of fields, length of fields, and such are exemplary and may be varied in particular embodiments in accordance with the present disclosure. The paging message may include a message header and zero or more paging records. The message header may include a PDU_Type field, shown in this example as a 3-bit field along with an extension bit E (that is, if there is a need to extend the PDU_Type field, the E bit would be set to 1, and some number of previously reserved bits would be allocated to extend the PDU_Type). The message header may further include a record count field C, shown in this example as a 5-bit field spanning the last (rightmost) four bits of the first octet and the first (leftmost) one bit of the second octet. For instance, a 5-bit field may allow up to 31 or 32 paging records in a single message, depending on whether 0 may be considered as a valid value for C, and the values may be interpreted as either 0 to 31 or 1 to 32. The remaining bits of the header—in this example, the rightmost seven bits of the second octet—may be reserved and indicated in FIG. 6 with an R. In some embodiments, additional fields may be present in the message header.

The header may be followed by a number of paging records, the number of paging records in a particular instance of the message in this example being indicated by the value of C in the header. Each paging record may include a Device_ID field of length K octets. (Notably, the example shown in FIG. 6 assumes that the device ID occupies an integer number of octets, but other lengths of the device ID may be accommodated, for instance, with padding or reserved bits in the paging record, by allowing the following field(s) to start away from an octet boundary, and so on.) As described above, the Device_ID may identify a single device, a plurality of devices, or all devices that receive the message.

Each paging record may further include a record length field (Record_Len in the figure), identifying a length of the paging record. The Record_Len may be in any suitable units, such as octets or bits (e.g., in octets as shown in FIG. 6). The value of Record_Len may be a total length of the record, a length of the record exclusive of the device ID, and so on, as long as it allows the device to determine unambiguously the size of the paging record in the message (so that, for example, a device can easily skip to the following paging record). In some embodiments, all fields subsequent to the Record_Len may be considered as part of a payload of the paging record. In some alternative embodiments, one or more of the fields may be considered as excluded from the payload. For example, the payload may be considered to include only the data block described below (with or without a length indicator). In some embodiments, there may be no formal definition of the “payload” of a paging record, and the record may be viewed only as a succession of fields.

Each paging record may further include a cause code (Cause in FIG. 6), which may, for instance, indicate whether the page is triggered by an application-layer request for data delivery to the device (for example, in DT operation), an application-layer request for data delivery from the device (for example, in DO-DTT operation), an upper-layer request for signaling, a data read and/or write command, a request for identification of the device, and so on. In some embodiments, the Cause may be associated with an extension bit (not shown in the figure) that allows future extension of the field in case additional values are needed (for instance, in a future release of the standard).

Each paging record may further include a transaction identifier (Transaction in FIG. 6), which may, for instance, be a short ID used to prevent devices from responding multiple times to the same paging request. Potential procedures for interpreting the Transaction by the device are described below.

Each paging record may further include an indication of radio resources for the device(s) to respond (Resp_Resources in the figure), which may describe radio resources in any suitable manner to allow a receiving device to determine on what radio resources it should transmit a response to the paging message. The Resp_Resources field is shown in FIG. 6 as occupying eight bits, but it may be of any suitable length to encode the needed information. In some embodiments, the Resp_Resources field may include one or more parameters for a random number generator and/or a hash function, thereby allowing multiple devices to respond to the page on different radio resources in order to avoid collisions.

Each paging record may further include a data included indicator (D in the figure), which may, for instance, be a flag indicating if data for the receiving device(s) are included in the paging record. In some embodiments, D may not be present in the paging record format, and the indication of whether data are present in the paging record may be based on the contents of the subsequently described Data_Len field. In other embodiments, the presence of the Data_Len field itself may be optional, with the field present if D is set to 1 and absent if D is set to 0, for example. In still other embodiments, D may not be present as a separate field in the paging record format, and the presence or absence of Data_Len and/or Data (as described below) may be indicated by the value of Cause. For example, if the Cause indicates that the paging record is sent to trigger a write operation, the device may be guided to expect that Data_Len and Data will be present to indicate the data that should be written to the device. (In such a case, either the format of the Data field or an additional field in the paging record may comprise an indication of a location to which the data should be written, such as a memory address, a logical address mapping to data storage on the device, and so on.) As another example, if the Cause indicates that the paging record is sent to trigger a read operation, the device may be guided to expect either a separate Address field in the paging record (not shown in FIG. 6) or address information embedded in the Data field, indicating a location from which the data should be read, such as a memory address, a logical address mapping to data storage on the device, and so on.

Each paging record may further include a new data response only indicator (N in FIG. 6), which may indicate that a receiving device should transmit a response only if it has data queued for transmission to the AIoT system. As one example, N may be set to 1 if the paging record addresses a group of sensors and the reader (or other elements of the system that request information from the reader) is only interested in receiving responses from sensors that have logged a detection event to be reported. In some embodiments, if N is set to 0, all addressed devices will respond, irrespective of whether they have stored data to be transmitted to the reader.

Each paging record may further include one or more reserved bits (R in the figure), which may, for instance, bring a portion of the paging record, such as the fields not used for data transmission, to an integer number of octets. In some embodiments, one or more of the bits shown as reserved may be used to extend the values of any other field in the paging record. Although FIG. 6 shows six reserved bits, it ought to be understood that any suitable number of reserved bits may be defined, depending on the lengths of the other fields in the paging record and the resulting octet alignment of the fields, for example.

Each paging record may further include a data length indicator (Data_Len in the figure), which may, for instance, be expressed as a number of bits. (In some embodiments, Data_Len may be expressed in other units such as octets.) Although FIG. 6 shows Data_Len as an eight-bit field, any suitable field size may be used. In some embodiments, the value of Data_Len may indicate if a data block follows as described below. For example, a data length of zero may be interpreted by the device to mean that no data block is present. In some embodiments, Data_Len may not be included explicitly, but the length of a subsequent block of data may be inferred from other information such as Record_Len (described above).

Each paging record may further include a block of data (Data in the figure), whose length is expressed by Data_Len as described above and whose contents may be any data destined for delivery to the device. In some embodiments, Data may occupy a substantially arbitrary number of bits, and padding bits may be added to bring the total size of the paging record to an integer number of octets, for example.

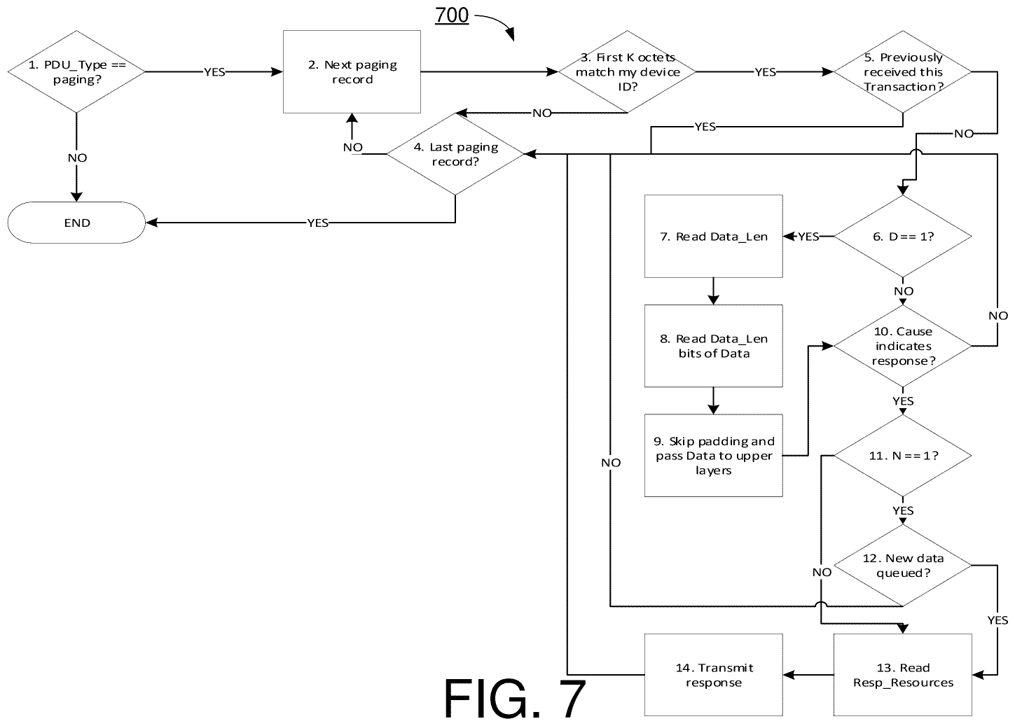

FIG. 7 illustrates an example procedure 700 of an exemplary AIoT paging message by a device under a proposed scheme in accordance with the present disclosure. Example procedure 700 may pertain to the processing of an exemplary AIoT paging message by a device, based on the message format of FIG. 6 and under a proposed scheme in accordance with the present disclosure. The flowchart begins when a device has received a message. In step 1, the device evaluates whether the PDU_Type from the message indicates paging. If the result of step 1 is “no”, the (paging) procedure ends (presumably in favor of other processing appropriate to the message type); otherwise, if “yes”, the device proceeds to step 2. Step 2 iterates over the paging records in the message, starting from the first one.

In step 3, the device evaluates whether the first K octets of the message match a device ID assigned to the device (where K is determined based on the identifier size, where the device may have one or multiple individual and/or group IDs assigned to it, and where the “match” process is understood according to the procedures previously described, e.g., potentially considering an “ID type” field, group IDs, masks, a reserved value for “all devices”, and so on). If the result of step 3 is “no”, the device proceeds to step 4, where the device determines if the current paging record is the last paging record; if so, the procedure ends, and if not, the procedure returns to the iterator in step 2 (that is, it proceeds to process the next paging record, which may, for instance, involve skipping the remainder of the current paging record based on an indicated or inferred record length). On the other hand, if the result of step 3 is “yes”, the device proceeds to step 5, which may be described as a “freshness check” where the device evaluates whether it has previously received signaling for the same Transaction as indicated in the message. If the result of step 5 is “yes”, the device proceeds to step 4 to iterate to the next paging record (if any); otherwise, if the result of step 5 is “no”, the device proceeds to step 6 (while retaining the knowledge that it has now received a message for this value of Transaction). This mechanism can prevent multiple processing of the same paging information by the device, which may, for example, be useful if a paging record addressed to a group of devices is repeated for the benefit of any devices in the group that may not previously have received it.

In step 6, the device evaluates if D is equal to 1 (i.e., if a data block is present in the message). If the result of step 6 is “yes”, the device reads Data_Len from the message (step 7), reads Data_Len bits of data from the message (step 8), and skips any padding and passes the data to upper layers (step 9), then proceeds to step 10. If the result of step 6 is “no”, the device proceeds directly to step 10.

In step 10, the device evaluates whether the Cause value from the message indicates that a response should be sent. If the result of step 10 is “no”, the device proceeds to step 4 to iterate to the next paging record (if any); otherwise, if the result of step 10 is “yes”, the device proceeds to step 11. In step 11, the device evaluates whether N is 1 (i.e., whether a response was requested only from devices having new data queued for transmission). If the result of step 11 is “yes”, the device proceeds to step 12. If the result of step 11 is “no”, the device proceeds to step 13.

In step 12, the device checks whether it has new (not previously successfully transmitted) data queued for transmission. If the result of step 12 is “no”, the device proceeds to step 4 to iterate to the next paging record (if any); otherwise, if the result of step 12 is “yes”, the device proceeds to step 13.

In step 13, the device reads Resp_Resources from the paging message and proceeds to step 14. In step 14, the device transmits a paging response (e.g., using the radio resources indicated by Resp_Resources to initiate an AIoT random access procedure). Such an AIoT random access procedure may carry the paging response within a step of the AIoT random access procedure itself, or it may establish communication between the device and the reader in a manner that allows the paging response to be sent subsequently from the device to the reader. After step 14, the device proceeds to step 4 to iterate to the next paging record (if any).

In some embodiments, the functions of different fields described herein may be combined. As one example, N may be combined with Cause by having a first cause value meaning “a response is unconditionally requested” and a second cause value meaning “a response is requested only from devices having data to transmit”. As another example, D may be combined with Data_Len by having Data_Len be always present and setting it to 0 when no data block is included.

Although the examples described above may have a fixed-length device ID (K octets in the examples), it ought to be understood that there may be multiple types of device IDs with different lengths, or even device ID formats of variable length. Accordingly, a “Device_ID_Len” field and/or a “Device_ID_Type” field may be included in the paging record format, for example, immediately before the Device_ID, to indicate the length and/or the type of the device ID.

### Feature Highlight

In view of the above, key features of various proposed schemes in accordance with the present disclosure are highlighted below in the context of two example methods/processes.

In one aspect, in a method of processing an AIoT paging message by a device in an AIoT system, a device in the AIoT system may receive, from a reader, the AIoT paging message and process at least one paging record contained in the AIoT paging message. In processing the at least one paging record, the device may match a device identifier in the paging record to at least one identifier assigned to the device. Additionally, the device may determine whether the paging record requests a response. Moreover, in case that the paging record requests a response, the device may initiate an AIoT random access procedure on one or more radio resources determined in accordance with the contents of the paging message.

In some implementations, in determining whether the paging record requests a response, the device may evaluate whether a cause code of the paging message corresponds to a response procedure. In some implementations, the cause code may be contained in the paging record.

In some implementations, in determining whether the paging record requests a response, the device may evaluate whether a new data response only indicator of the paging message is set. In some implementations, the new data response only indicator may be contained in the paging record. In some implementations, when the new data response only indicator is set, the device may also determine that the paging record requests a response if the device has undelivered data queued for transmission. Alternatively, or additionally, when the new data response only indicator is not set, the device may also determine that the paging record requests a response.

In some implementations, in determining whether the paging record requests a response, the device may evaluate whether a transaction identifier of the paging message corresponds to a transaction identifier previously processed by the device.

In some implementations, the device may also determine if the paging record contains data for the device. Furthermore, the device may deliver the data to upper layers when the paging record contains data for the device.

In another aspect, in a method of transmitting an AIoT paging message by a reader in an AIoT system, the device may encode, in the AIoT paging message, a message type corresponding to paging, and the device may also encode, in the AIoT paging message, at least one paging record addressed to at least one device of the AIoT system. In encoding the at least one paging record, the device may encode, in the paging record, a device identifier assigned to the at least one device. Moreover, the device may encode, in the paging record, an indication of whether the paging record requests a response.

In some implementations, the indication of whether the paging record requests a response may include an indication to respond unconditionally.

In some implementations, the indication of whether the paging record requests a response may include an indication to respond only if the device has undelivered data queued for transmission.

In some implementations, the indication of whether the paging record requests a response may include an indication in a cause code of the paging message. In some implementations, the cause code may be contained in the paging record.

In some implementations, the reader may also encode, in the AIoT paging message, an indication of radio resources to be used by the device to respond to the paging message.

In some implementations, the reader may also encode, in the AIoT paging message, a transaction identifier.

In some implementations, the reader may also encode, in the AIoT paging message, data for the device.

### Illustrative Implementations

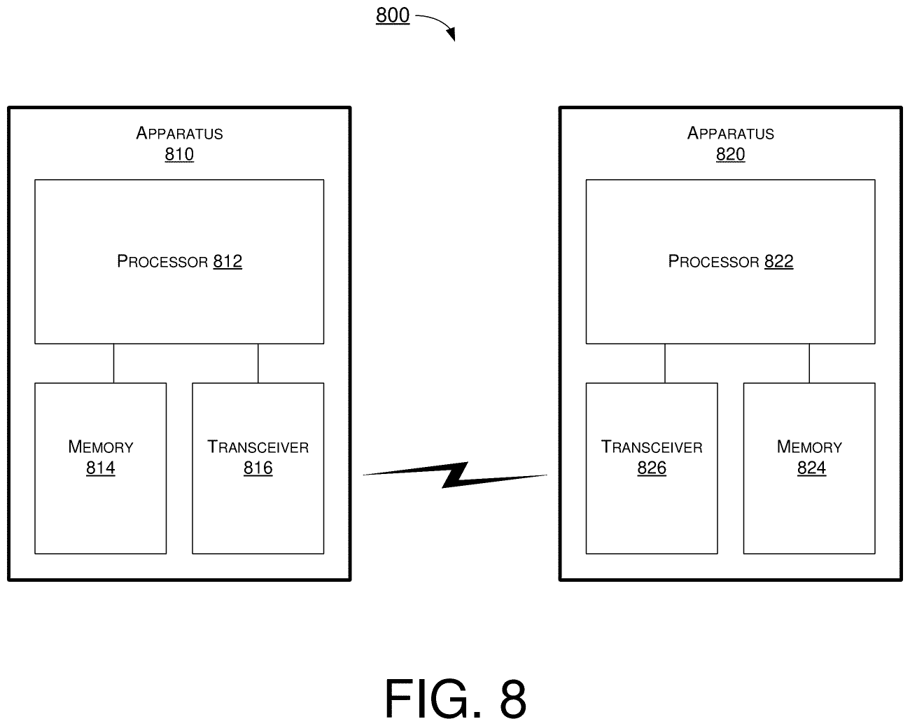

FIG. 8 illustrates an example system 800 having at least an example apparatus 810 and an example apparatus 820 in accordance with an implementation of the present disclosure. Each of apparatus 810 and apparatus 820 may perform various functions to implement schemes, techniques, processes and methods described herein pertaining to AIoT paging procedures and signaling in wireless communications, including the various schemes described above with respect to various proposed designs, concepts, schemes, systems and methods described above as well as processes described below. For instance, apparatus 810 may be implemented in or as a device or a UE and apparatus 820 may be implemented in or as another device or a cellular BS, or vice versa.

In some implementations, each of apparatus 810 and apparatus 820 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 810 and apparatus 820 may be implemented in or as a target UE or an anchor UE/positioning server UE. Each of apparatus 810 and apparatus 820 may include at least some of those components shown in FIG. 8 such as a processor 812 and a processor 822, respectively, for example. Each of apparatus 810 and apparatus 820 may further include one or more other components not pertinent to the proposed scheme of the present disclosure (e.g., internal power supply, display device and/or user interface device), and, thus, such component(s) of apparatus 810 and apparatus 820 are neither shown in FIG. 8 nor described below in the interest of simplicity and brevity.

In one aspect, each of processor 812 and processor 822 may be implemented in the form of one or more single-core processors, one or more multi-core processors, one or more RISC processors or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed for AIoT paging procedures and signaling in wireless communications in accordance with various implementations of the present disclosure.

In some implementations, apparatus 810 may also include a transceiver 816 coupled to processor 812. Transceiver 816 may include a transmitter capable of wirelessly transmitting and a receiver capable of wirelessly receiving data. In some implementations, apparatus 820 may also include a transceiver 826 coupled to processor 822. Transceiver 826 may include a transmitter capable of wirelessly transmitting and a receiver capable of wirelessly receiving data. It is noteworthy that, although transceiver 816 and transceiver 826 are illustrated as being external to and separate from processor 812 and processor 822, respectively, in some implementations, transceiver 816 may be an integral part of processor 812 as a system on chip (SoC), and transceiver 826 may be an integral part of processor 822 as a SoC.

In some implementations, apparatus 810 may further include a memory 814 coupled to processor 812 and capable of being accessed by processor 812 and storing data therein. In some implementations, apparatus 820 may further include a memory 824 coupled to processor 822 and capable of being accessed by processor 822 and storing data therein. Each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

Each of apparatus 810 and apparatus 820 may be a communication entity capable of communicating with each other using various proposed schemes in accordance with the present disclosure. For illustrative purposes and without limitation, a description of capabilities of apparatus 810, as a target UE, and apparatus 820, as an anchor UE/positioning server UE, is provided below in the context of example processes 900 and 1000. It is noteworthy that, although a detailed description of capabilities, functionalities and/or technical features of one of apparatus 810 and apparatus 820 is provided below, the same may be applied to the other of apparatus 810 and apparatus 820 although a detailed description thereof is not provided solely in the interest of brevity. It is also noteworthy that, although the example implementations described below are provided in the context of sidelink communications in a mobile network, the same may be implemented in other types of networks.

### Illustrative Processes

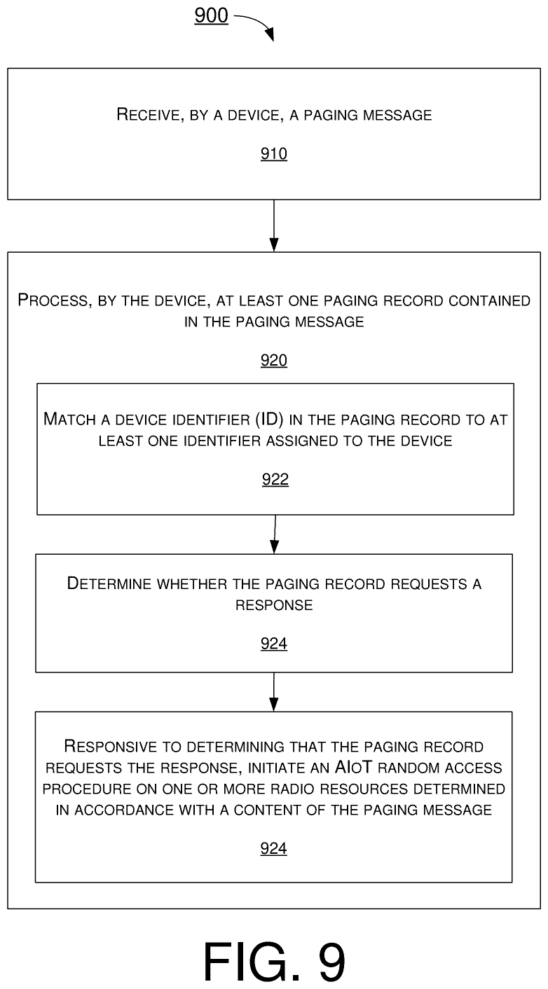

FIG. 9 illustrates an example process 900 in accordance with an implementation of the present disclosure. Process 900 may represent an aspect of implementing various proposed designs, concepts, schemes, systems and methods described above. More specifically, process 900 may represent an aspect of the proposed concepts and schemes pertaining to AIoT paging procedures and signaling in wireless communications in accordance with the present disclosure. Process 900 may include one or more operations, actions, or functions as illustrated by one or more of blocks 910 and 920 as well as subblocks 922, 924 and 926. Although illustrated as discrete blocks, various blocks of process 900 may be divided into additional blocks, combined into fewer blocks, or eliminated, depending on the desired implementation. Moreover, the blocks/sub-blocks of process 900 may be executed in the order shown in FIG. 9 or, alternatively, in a different order. Furthermore, one or more of the blocks/sub-blocks of process 900 may be executed repeatedly or iteratively. Process 900 may be implemented by or in apparatus 810 and apparatus 820 as well as any variations thereof. Solely for illustrative purposes and without limiting the scope, process 900 is described below in the context of apparatus 810 implemented in or as a device and apparatus 820 implemented in or as a reader of a wireless network such as a mobile network in accordance with one or more of 3GPP standards. Process 900 may begin at block 910.

At 910, process 900 may involve processor 812 of apparatus 810 receiving, via transceiver 816, the paging message (e.g., from apparatus 820 as a reader). Process 900 may proceed from 910 to 920.

At 920, process 900 may involve processor 812 processing at least one paging record contained in the paging message. The processing may be represented by 922, 924 and 926.

At 922, process 900 may involve processor 812 matching a device identifier (ID) in the paging record to at least one identifier assigned to the device. Process 900 may proceed from 922 to 924.

At 924, process 900 may involve processor 812 determining whether the paging record requests a response. Process 900 may proceed from 924 to 926.

At 926, process 900 may involve processor 812 initiating an AIoT random access procedure on one or more radio resources determined in accordance with a content of the paging message in response to determining that the paging record requests the response.

In some implementations, in determining whether the paging record requests a response, process 900 may involve processor 812 evaluating whether a cause code of the paging message corresponds to a response procedure. In some implementations, the cause code may be contained in the paging record.

In some implementations, in determining whether the paging record requests a response, process 900 may involve processor 812 evaluating whether a new data response only indicator of the paging message is set. In some implementations, the new data response only indicator is contained in the paging record. In some implementations, process 900 may further involve processor 812 determining that the paging record requests the response in an event that the device has undelivered data queued for transmission in response to determining that the new data response only indicator being set. Alternatively, or additionally, process 900 may further involve processor 812 determining that the paging record requests the response in response to determining that the new data response only indicator being not set.

In some implementations, in determining whether the paging record requests a response, process 900 may involve processor 812 evaluating whether a transaction identifier of the paging message corresponds to a transaction ID previously processed by the device.

In some implementations, process 900 may further involve processor 812 determining whether the paging record contains data for the device. Additionally, process 900 may involve processor 812 delivering the data to an upper layer responsive to the paging record containing the data for the device.

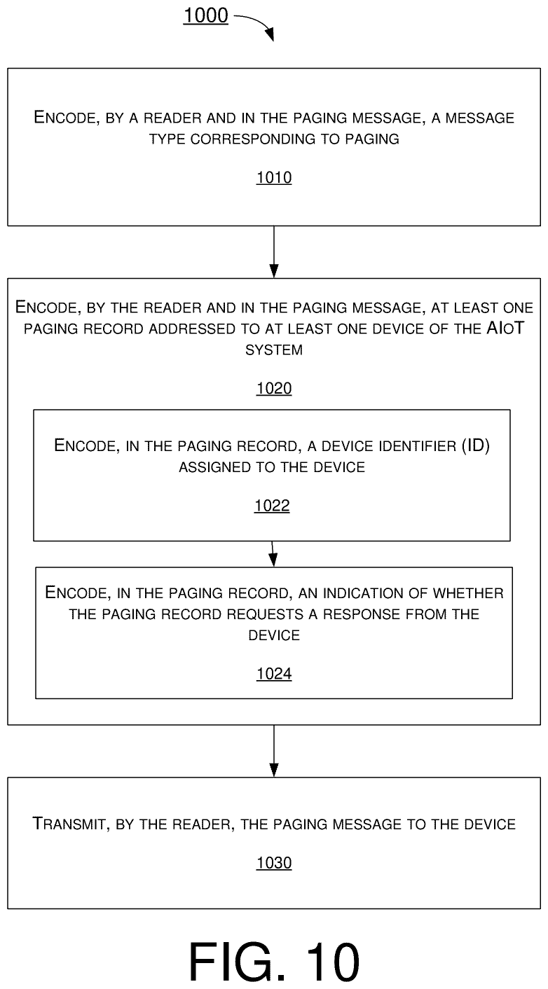

FIG. 10 illustrates an example process 1000 in accordance with an implementation of the present disclosure. Process 1000 may represent an aspect of implementing various proposed designs, concepts, schemes, systems and methods described above. More specifically, process 1000 may represent an aspect of the proposed concepts and schemes pertaining to AIoT paging procedures and signaling in wireless communications in accordance with the present disclosure. Process 1000 may include one or more operations, actions, or functions as illustrated by one or more of blocks 1010, 1020 and 1030 as well as subblocks 1022 and 1024. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively, in a different order. Furthermore, one or more of the blocks/sub-blocks of process 1000 may be executed repeatedly or iteratively. Process 1000 may be implemented by or in apparatus 810 and apparatus 820 as well as any variations thereof. Solely for illustrative purposes and without limiting the scope, process 1000 is described below in the context of apparatus 810 implemented in or as a device and apparatus 820 implemented in or as a reader of a wireless network such as a mobile network in accordance with one or more of 3GPP standards. Process 1000 may begin at block 1010.

At 1010, process 1000 may involve processor 822 of apparatus 820 encoding, in a paging message, a message type corresponding to paging. Process 1000 may proceed from 1010 to 1020.

At 1020, process 1000 may involve processor 822 encoding, in the paging message, at least one paging record addressed to at least one device of the AIoT system (e.g., apparatus 810). Process 1000 may proceed from 1020 to 1030.

At 1030, process 1000 may involve processor 822 transmitting, via transceiver 826, the paging message to the device.

The encoding of at least one paging record addressed to at least one device of the AIoT system may be represented by 1022 and 1024.

At 1022, process 1000 may involve processor 822 encoding, in the paging record, a device ID assigned to the device. Process 1000 may proceed from 1022 to 1024.

At 1024, process 1000 may involve processor 822 encoding, in the paging record, an indication of whether the paging record requests a response from the device.

In some implementations, the indication of whether the paging record requests a response may include an indication to respond unconditionally.

In some implementations, the indication of whether the paging record requests a response may include an indication to respond in an event that the device has undelivered data queued for transmission.

In some implementations, the indication of whether the paging record requests a response may include an indication in a cause code of the paging message. In some implementations, the cause code may be contained in the paging record.

In some implementations, process 1000 may further involve processor 822 encoding, in the paging message, an indication of one or more radio resources to be used by the device in responding to the paging message.

In some implementations, process 1000 may further involve processor 822 encoding, in the paging message, a transaction identifier (ID).

In some implementations, process 1000 may further involve processor 822 encoding, in the paging message, data for the device.

### Additional Notes

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of processing a paging message in an ambient Internet of Things (AIoT) system, comprising:
receiving, by a device, the paging message; and
processing, by the device, at least one paging record contained in the paging message by:
matching a device identifier (ID) in the paging record to at least one identifier assigned to the device;
determining whether the paging record requests a response; and
responsive to determining that the paging record requests the response, initiating an AIoT random access procedure on one or more radio resources determined in accordance with a content of the paging message.

2. The method of claim 1, wherein the determining whether the paging record requests a response comprises evaluating whether a cause code of the paging message corresponds to a response procedure.

3. The method of claim 2, wherein the cause code is contained in the paging record.

4. The method of claim 1, wherein the determining whether the paging record requests a response comprises evaluating whether a new data response only indicator of the paging message is set.

5. The method of claim 4, wherein the new data response only indicator is contained in the paging record.

6. The method of claim 4, further comprising:
responsive to determining that the new data response only indicator is set, determining that the paging record requests the response in an event that the device has undelivered data queued for transmission.

7. The method of claim 4, further comprising:
responsive to determining that the new data response only indicator is not set, determining that the paging record requests the response.

8. The method of claim 1, wherein the determining whether the paging record requests a response comprises evaluating whether a transaction identifier of the paging message corresponds to a transaction identifier (ID) previously processed by the device.

9. The method of claim 1, further comprising:
determining whether the paging record contains data for the device.

10. The method of claim 9, further comprising:
delivering the data to an upper layer responsive to the paging record containing the data for the device.

11. A method of transmitting a paging message in an ambient Internet of Things (AIoT) system, comprising:
encoding, by a reader and in the paging message, a message type corresponding to paging;
encoding, by the reader and in the paging message, at least one paging record addressed to at least one device of the AIoT system by:
encoding, in the paging record, a device identifier (ID) assigned to the device; and
encoding, in the paging record, an indication of whether the paging record requests a response from the device; and
transmitting, by the reader, the paging message to the device.

12. The method of claim 11, wherein the indication of whether the paging record requests a response comprises an indication to respond unconditionally.

13. The method of claim 11, wherein the indication of whether the paging record requests a response comprises an indication to respond in an event that the device has undelivered data queued for transmission.

14. The method of claim 11, wherein the indication of whether the paging record requests a response comprises an indication in a cause code of the paging message.

15. The method of claim 14, wherein the cause code is contained in the paging record.

16. The method of claim 11, further comprising:
encoding, by the reader and in the paging message, an indication of one or more radio resources to be used by the device in responding to the paging message.

17. The method of claim 11, further comprising:
encoding, by the reader and in the paging message, a transaction identifier (ID).

18. The method of claim 11, further comprising:
encoding, by the reader and in the paging message, data for the device.

19. An apparatus implementable in a device in an ambient Internet of Things (AIoT) system, comprising:
a transceiver configured to communicate wirelessly; and
a processor coupled to the transceiver and configured to perform operations comprising:
receiving, via the transceiver, the paging message; and
processing at least one paging record contained in the paging message by:
matching a device identifier (ID) in the paging record to at least one identifier assigned to the device;
determining whether the paging record requests a response; and
responsive to determining that the paging record requests the response, initiating an AIoT random access procedure on one or more radio resources determined in accordance with a content of the paging message.

20. The apparatus of claim 19, wherein the determining whether the paging record requests a response comprises:
evaluating whether a cause code of the paging message corresponds to a response procedure; or
evaluating whether a new data response only indicator of the paging message is set; or
evaluating whether a transaction identifier of the paging message corresponds to a transaction identifier (ID) previously processed by the device.
